(19) United States
(12) Patent Application Publication
(10) Pub. No.: US 2003/0180711 A1
(43) Pub. Date: Sep. 25, 2003

(54) Three dimensional microfluidic device having porous membrane

(76) Inventors: Stephen W. Turner, Ithaca, NY (US); Jun Kameoka, Ithaca, NY (US); Hye Yoon Park, Ithaca, NY (US); Harold G. Craighead, Ithaca, NY (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/372,016

(22) Filed: Feb. 21, 2003

Related U.S. Application Data
(60) Provisional application No. 60/359,118, filed on Feb. 21, 2002.

(51) Int. Cl. C12Q 1/00; B29B 7/00; C12M 1/34

(52) U.S. Cl. 435/4; 435/287.2; 156/242

(57) ABSTRACT

A three dimensional microfluidic device is formed by placing a membrane between two micropatterned chips. The membrane is positioned to cover the area where channels intersect. In one embodiment the membrane is porous. The chips are formed of plastic, and are thermally bonded under pressure. Reservoirs are formed on the chips at each end of each channel. The channels are created in the chip by use of an embossing master, such as a patterned silicon wafer. The reservoirs are formed by drilling. A hydraulic press is used to emboss both chips, and is also used to thermally bond the chips and membrane under pressure. The surfaces of the channels are oxidized, changing the surfaces from hydrophobic to hydrophilic.

### RELATED APPLICATIONS

This application claims priority to U.S. Provisional Patent Application Serial No. 60/359,118, filed Feb. 21, 2002, which is incorporated herein by references.

### FIELD OF THE INVENTION

The present invention relates to microfluidic devices, and in particular to a microfluidic device having a porous membrane.

### BACKGROUND OF THE INVENTION

Microfluidic devices have many applications in chemical and biological assays, such as drug screening, nucleic acid separation and protein separation. Some filter cartridges use a porous membrane having many holes etched through a substrate for high performance liquid chromatography (HPLC), DNA separation and protein separation. The throughput for such cartridges is relatively low, and the cost per assay is high.

### SUMMARY OF THE INVENTION

A three dimensional microfluidic device is formed by placing a membrane between two micropatterned chips. The patterning in one embodiment comprises intersecting channels, wherein the membrane is positioned to cover the area where the channels intersect. In one embodiment, channels are formed in polycarbonate chips. A porous membrane is placed between the chips. The chips are positioned such that the channels intersect at approximately a right angle. The chips are then bonded. In one embodiment, the chips are formed of plastic, and are thermally bonded under pressure.

In a further embodiment, reservoirs are formed on the chips at each end of each channel. The channels are created in the chip by use of an embossing master, such as a patterned silicon wafer. The reservoirs are formed by drilling. A hydraulic press is used to emboss both chips, and is also used to thermally bond the chips and membrane under pressure. In a further embodiment, the surfaces of the channels are oxidized, changing the surfaces from hydrophobic to hydrophilic.

A method of molecule separation is performed using the microfluidic device. In one embodiment, DNA is placed in one reservoir, and moved to the membrane by a low voltage. A short electric pulse is applied to drive the DNA through the porous membrane. After the pulse, short DNA molecules have moved completely through the porous membrane, while longer DNA molecules have only partially moved into the holes of the porous membrane. After the pulse, when voltage is zero, longer DNA molecules recoil out of the holes of the porous membrane. After multiple iterations of electric pulses, short DNA molecules have moved completely through the porous membrane, while longer DNA molecules have not moved through the porous membrane, resulting in separation of the DNA molecules by length. The electric pulses are varied to provide separation of different length molecules.

### BRIEF DESCRIPTION OF THE DRAWINGS

FIG. 1 is an exploded three dimensional perspective view of a microfluidic device formed in accordance with the present invention.

FIG. 2 is block diagram showing top view illustrating features of the microfluidic device of FIG. 1.

FIG. 3 is a block diagram showing use of the microfluidic device of FIG. 1 in the separation of molecules.

FIGS. 4A, 4B, 4C, 4D, 4E and 4F are a series of block diagrams showing the formation of the microfluidic device of FIG. 1.

FIG. 5 is a SEM image of a polycarbonate membrane for the microfluidic device of FIG. 1.

FIG. 6 is a cross sectional representation of a molecule moving through a single pore of a membrane.

FIG. 7 is a graphical representation of the intensity of tagged DNA molecules that have passed through the porous membrane.

FIG. 8 is an exploded view of a three dimensional multilevel microfluidic device.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be-taken in a limited sense, and the scope of the present invention is defined by the appended claims.

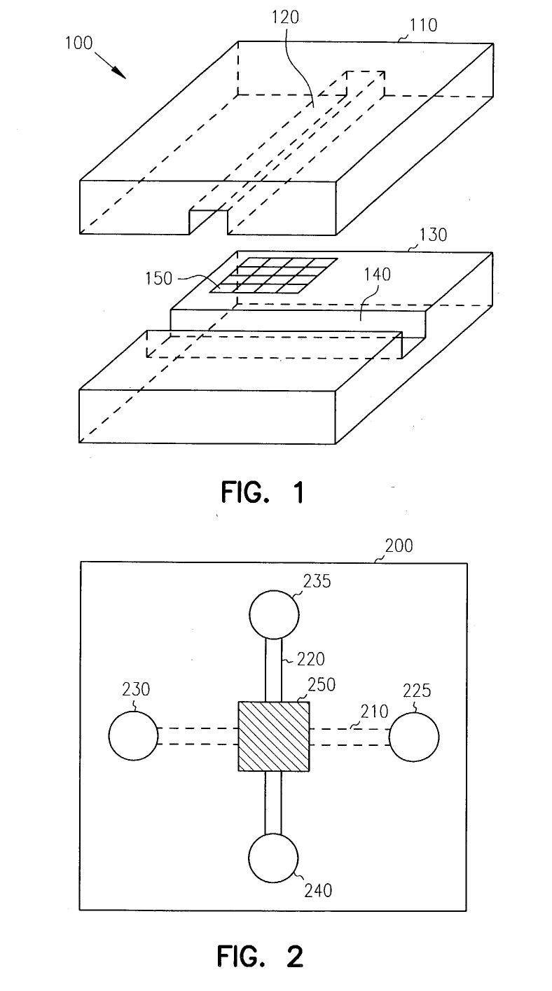

A microfluidic device formed in accordance with the present invention is shown in an exploded view at 100 in FIG. 1. A first plastic layer or chip 110 has a channel 120 formed therein. A second plastic chip 130 also has a channel 140 formed therein. The chips are formed of a polymeric optical grade plastic, such as ZEONOR® in one embodiment. Polyethylene, polypropylene, other plastics and other materials such as semiconductor materials are used in further embodiments. Channels are just one example of micropatterning to produce microfeatures that is achievable. Many different microfeatures may be produced, including but not limited to sensors, reservoirs, and any other structure that may produced.

The two chips are positioned relative to each other such that the channels 120 and 140 are positioned at approximately right angles to each other in one embodiment, and a membrane 150 is positioned between the two chips where the channels intersect. The intersection creates a substantially square aperture covered by the membrane separating the two channels, top and bottom, from each other. In one embodiment, the membrane is porous. The membrane 150 is large enough to entirely cover and extend partially beyond the intersection of the channels 120 and 140 in one embodiment such that substances mainly travel through the membrane to move from one channel to the other channel. The chips and membrane are bonded to form a three dimensional microfluidic device. In one embodiment, the membrane 150 is substantially flat, with essentially no wrinkles.

In further embodiments, the channels or other micropatterning are not perpendicular, and the membrane is formed in a suitable shape to cover the intersection of the patterning as desired. The membrane is formed in size corresponding to the size of the chips in a further embodiment, and more than one set of channels are formed in the chips. In still further embodiments, the channels are not formed in straight lines, and may also intersect in more than one point.

In one embodiment, the porous membrane is a Nuclepore® (Trademark of Whatman PLC) polycarbonate porous membrane that has many small holes etched through a substrate. The hole size is about 15 nm-5 um and the thickness of the membrane is about 6 um-20 um. The hole size is comparable to the size of some DNA and protein, and is suitable for use as an entropic trap for filtration of DNA and protein. The service temperature of this membrane is high, therefore, it is easily integrated into microfluidic systems by the use of thermal bonding between polymers.

In further embodiments, membranes have pores in only some portions, and allow for cross flow filtration. Many other uses are available, such as for running cleaning solutions between two membranes, adding nutrients to solutions, introduction of reagents from one channel to cells in a channel opposite the membrane, diffusive transport access and many others. In addition, this method of juxtaposing two fluid channels may facilitate the implementation of fuel cell methods with lower cost of contruction, greater efficiency, or other benefits. The use of a membrane sandwiched between micropatterned chips provides a basic construction tool for fabrication of micro devices.

FIG. 2 provides a top view of a further three dimensional microfluidic device at 200. Intersection channels 210 and 220 are formed, with channel 210 being a bottom channel and channel 220 forming a top channel. Channel 210 has a reservoir 225 and 230 formed at each end of the channel. Similarly, channel 220 has a reservoir 235 and 240 formed on each end of the channel. A membrane 250 is disposed between the channels at their intersection. In one embodiment, the channel width was approximately 40 um and depth approximately 20 um. In essence, the range of sizes of channels and other micropatterning is very great depending on the intended use. The reservoirs were substantially larger in order to hold substances to be separated, such as DNA and protein. It should be noted that many other sizes of channels are utilizable depending on the size of membrane achievable and the desired throughput of the device.

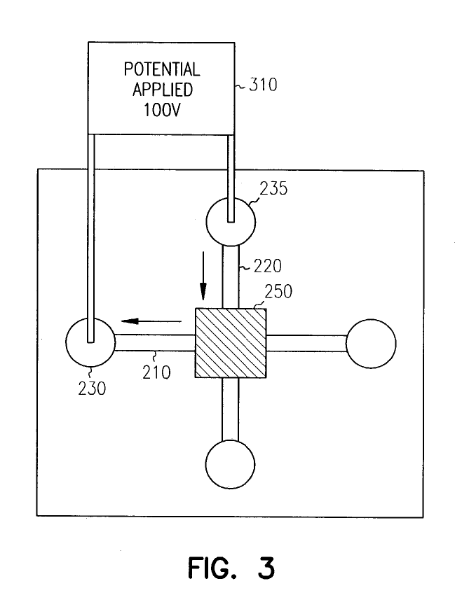

FIG. 3 provides a top view of the device of FIG. 2 with a voltage source 310 applying a 100 volt electric potential across reservoir 235 and reservoir 230, with reservoir 230 grounded. In one embodiment, T2 and T7 DNA were placed in reservoir 230. Since T2 and T7 DNA molecules are negatively charged, they flow from reservoir 230 to 235. They pass through the membrane with essentially no leaking. The voltage is varied in different embodiments to obtain different rates of flow and filtration as desired. In yet further embodiments, other means of causing flow are provided, such as heat pumps, differential pressures, gravity, capillary action, and osmosis to name a few.

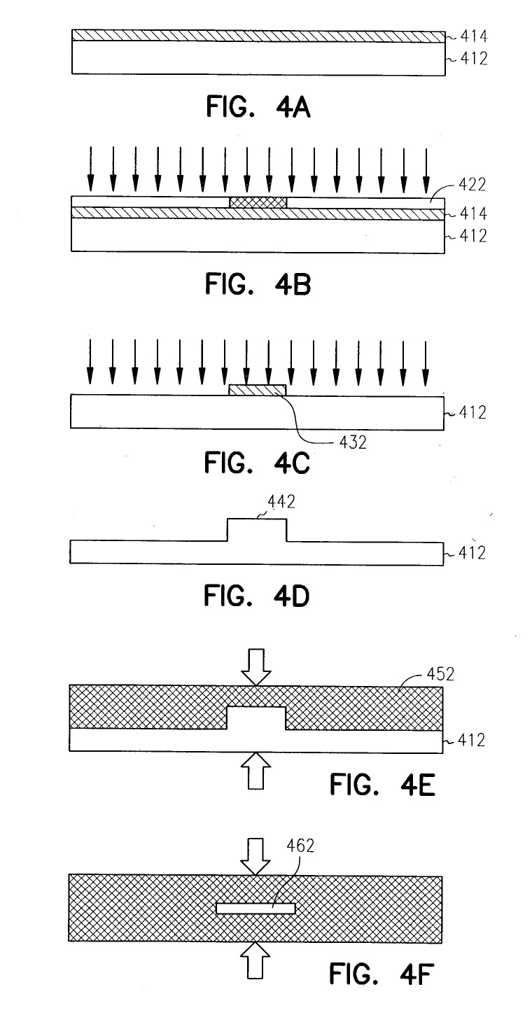

FIGS. 4A, 4B, 4C, 4D, 4E, and 4F depict a process of forming a three-dimensional microfluidic chip in accordance with the present invention. In FIG. 4A, a silicon wafer 412 is covered in a photoresist 414 for patterning. Silicon wafer 412 is a three inch silicon wafer that is used as an embossing master. A Shiply 1813 photoresist (Microchem, Newton, Mass.) is spin coated at 3000 RPM for 90 seconds on the silicon wafer in one embodiment. The thickness of the photoresist is approximately 1.3 um. Other photoresists and silicon wafers are also options.

In FIG. 4B, an HTG contact aligner is used for standard photolithographic processing to pattern ridges in the photoresist by use of a mask 422. In FIG. 4C, the silicon is etched using SF₆ in one embodiment. The ridge 432 of photoresist is not etched. The etching is performed in a Plasmatherm ICP770 to a depth of 20 um. After the etching process, the photoresist is removed with acetone and plasma etching to form the embossing master as shown in FIG. 4D having a ridge of silicon 442 for forming channels in plastic chips.

A first plastic chip 452 is cleaned such as by acetone for two minutes in an ultrasonic bath, and cut into a desired size, such as 2.0 cm×2.0 cm. The chip is then placed in contact with the silicon master with heat (approximately 130 degrees C.) and pressure from both top and bottom for embossing of the chip for about 7 minutes as shown in FIG. 4E. A second chip is processed in the same manner. The times, pressures and temperatures may be varied as desired.

Two of the chips are then equipped with four holes for reservoirs. The holes are approximately 2 mm in one embodiment and are formed by use of a conventional drill with low RPM to prevent melting of the plastic. The holes are formed in any manner suitable, such as photolithographic processing at the same time as the channels.

In FIG. 4F, two chips and a membrane are positioned relative to each other as shown in FIG. 1, and heated to approximately 85 degrees C. under pressure for approximately 10 to 15 minutes using a thermal press machine. The same machine is used in one embodiment for both embossing of the chips and bonding of the chips to form the microfluidic chip.

In one embodiment, a H₂SO₄/CrO₃ solution is injected into the microfluidic channels to oxidize the surface of the plastic. The oxidation changes the surface of the plastic from hydrophobic to hydrophilic.

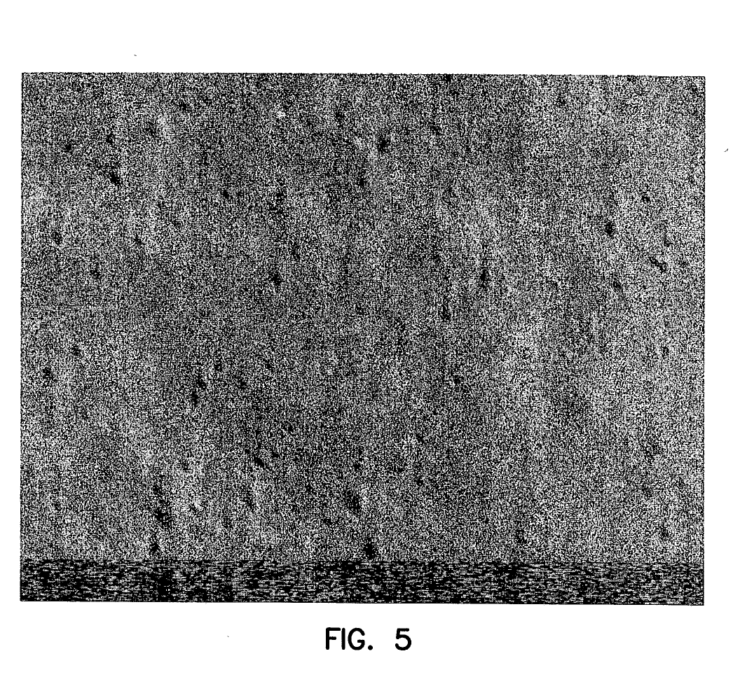

A SEM image of a membrane is shown in FIG. 5, illustrating the pores. The pores comprise holes that are approximately 0.05 to 10 um in width, and approximately 6.0 to 11.0 um thick. The material is biologically inert.

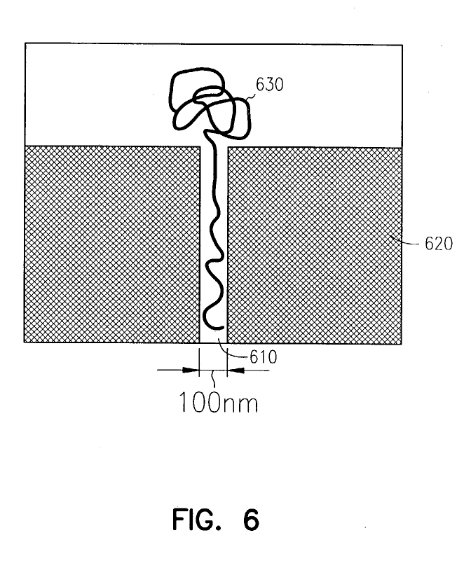

FIG. 6 is a representation of hole 610 in a porous membrane 620. Membrane 620 contains thousands of such pores in one embodiment. Hole 610 is approximately 100 nm wide, and is shown with a molecule 630 partially inserted into the hole. This is caused by application of an electric field.

A method of molecule separation is performed using the microfluidic device by application of electric fields across the membrane as shown in FIG. 3. In one embodiment, DNA is placed in one reservoir, and moved to the membrane by a low voltage. A short electric pulse is applied to drive the DNA through the porous membrane. After the pulse, short DNA molecules have moved completely through the porous membrane, while longer DNA molecules have only partially moved into the holes of the porous membrane. After the pulse, when voltage is zero, longer DNA molecules recoil out of the holes of the porous membrane by a process referred to as entropic recoil. After multiple iterations of electric pulses, short DNA molecules have moved completely through the porous membrane, while longer DNA molecules have not moved through the porous membrane, resulting in entropic recoil separation of the DNA molecules by length. The electric pulses are varied to provide separation of different length molecules.

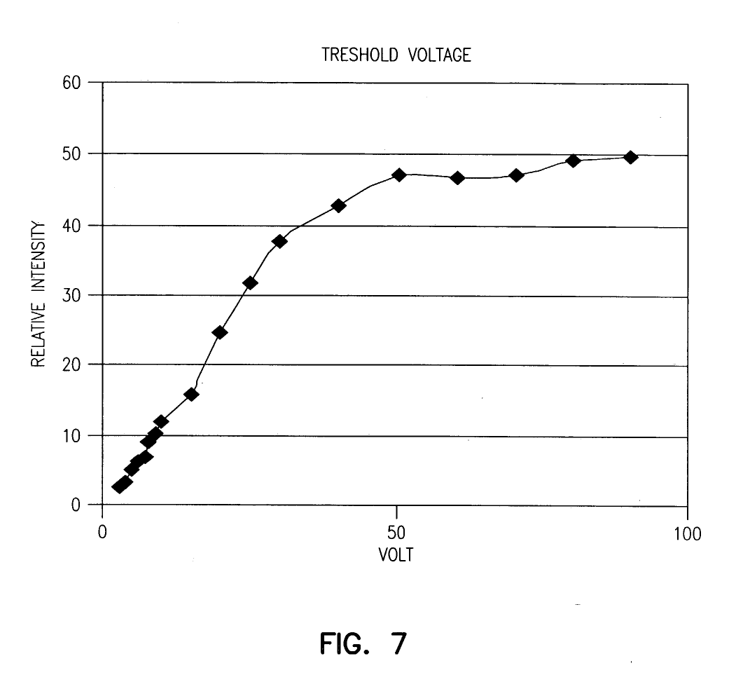

FIG. 7 is a graphical representation of the intensity of tagged DNA molecules that have passed through the porous membrane. As the voltage across the membrane was increased, the relative intensity of the molecules increases.

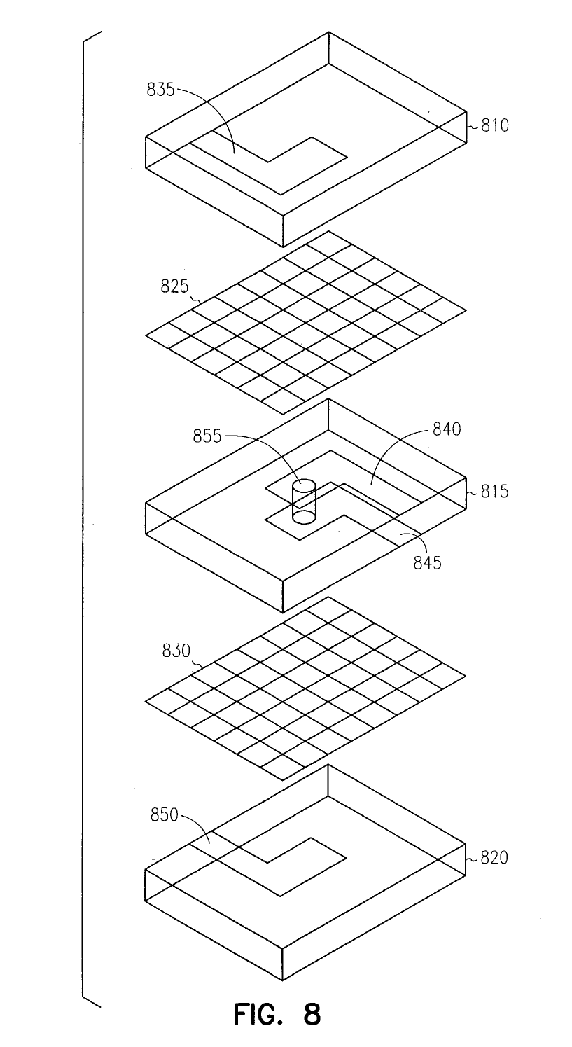

FIG. 8 is an exploded view of a three dimensional multilevel microfluidic device. Three layers, top layer 810, middle layer 815 and bottom layer 820 are separated by two porous membranes 825 and 830. Each adjacent layer has a structure, such as a microfluidic channel. Top layer 810 has a channel 835. Middle layer 815 has a structure such as a channel on each side, 840 and 845 respectively for fluid transport. Bottom layer 820 also has a channel 850. Channels of adjacent layers may partially overlap, and may or may not be separated from each other by one of the membranes. Middle layer 815 also has a via 855 formed through it, connecting channels 840 and 845. The via 855 provides for fluid flow between multiple levels. While particular structures, and positions of the structures are described in this example device, other arrangements are also within the scope of the invention, such as four layers, and different shaped membranes. Many different variations may be utilized.

### CONCLUSION

The present invention involves the use of a membrane positioned between two micro patterned surfaces. Many different types of membranes are used in various embodiments. While the membrane is described as substantially flat, it may also be contoured as desired, such as accordion shaped in portions to increase effective surface areas. The micro patterned surfaces are also formed of multiple different types of materials using many different processes. The membrane is coupled to the patterned surfaces in one of many different manners. Thermal bonding coupled with pressure is just one method of adhering the membranes and micro patterned surfaces.

1. A microfluidic device comprising:
a first micropatterned surface;
a second micropatterned surface facing and coupled to the first micropatterned surface; and
a membrane disposed between the two micropatterned surfaces separating a channel of the first micropatterned surface from a channel of the second micropatterned surface.

2. The device of claim 1 wherein the surfaces are formed of plastic.

3. The device of claim 1 wherein the patterning comprises a channel on each surface.

4. The device of claim 3 wherein the channel on the first surface is positioned substantially perpendicular to the channel on the second surface such that the channels intersect.

5. The device of claim 4 wherein the membrane is positioned to extend beyond the areas of intersection of the channels.

6. The device of claim 5 wherein the first and second surfaces are bonded together.

7. The device of claim 6 wherein fluid from one channel can only enter the other channel substantially through the membrane.

8. The device of claim 3 wherein the channel on the first surface is positioned substantially parallel to and overlapping with the channel on the second surface.

9. The device of claim 1 wherein selected portions of the membrane are porous.

10. The device of claim 1 wherein the membrane comprises a polycarbonate porous membrane having small holes etched through a substrate.

11. A microfluidic device comprising:
a first micropatterned surface;
a second micropatterned surface facing and coupled to the first micropatterned surface; and
a membrane disposed between the two micropatterned surfaces to separate portions of the first micropatterned surface from the second micropatterned surface.

12. The device of claim 11 wherein the membrane is positioned to extend beyond areas of intersection of the patterns on the first and second surfaces.

13. The device of claim 12 wherein fluid from one channel can only enter the other channel substantially through the membrane.

14. The device of claim 11 wherein selected portions of the membrane are porous.

15. The device of claim 11 wherein the membrane comprises a polycarbonate porous membrane having small holes etched through a substrate.

16. A method of forming a microfluidic device, the method comprising:
micropatterning a first surface;
micropatterning a second surface;
placing a membrane between the first and second surfaces; and
adhering the first surface to the second surface with the membrane positioned therebetween.

17. The method of claim 16 wherein the surfaces are formed of plastic.

18. The method of claim 16 wherein the patterning comprises a channel on each surface.

19. The method of claim 18 wherein the channel on the first surface is positioned substantially perpendicular to the channel on the second surface such that the channels intersect prior to adhering the first surface to the second surface.

20. The method of claim 15 and further comprising oxidizing the first and second micropatterned surfaces, changing the surfaces from hydrophobic to hydrophilic.

21. A method of forming a microfluidic device, the method comprising:
forming a mold having micropatterning;
creating a first micropatterned surface form the mold;
creating a second micropatterned surface form the mold;
placing a membrane between the first and second surfaces; and
adhering the first surface to the second surface with the membrane positioned therebetween.

22. The method of claim 21 wherein the mold is formed by photolithography.

23. The method of claim 22 wherein the mold is formed with a ridge.

24. The method of claim 23 wherein the surfaces are formed on chips of plastic by use of thermal embossing with the mold.

25. The method of claim 24 and further comprising applying pressure during the thermal embossing.

26. The method of claim 21 wherein a second mold is formed for creation of the second surface.

27. The method of claim 21 and further comprising oxidizing the first and second micropatterned surfaces, changing the surfaces from hydrophobic to hydrophilic.

28. A method of separating molecules by length, the method comprising:
placing molecules of different lengths in a first reservoir separated from a second reservoir by a pourous membrane;
applying an electric field across the membrane of sufficient strength to move the molecules to the membrane; and
pulsing the electric field to move shorter molecules through the membrane into the second reservoir.

29. The method of claim 28 and further comprising removing the electric filed between pulses such that longer molecules entropically recoil from the membrane.

30. A microfluidic device comprising:
multiple layers, each having a micropatterned surface; and
a membrane disposed between adjacent layers and micropatterned surfaces to separate portions of the micropatterned surfaces from portions of adjacent micropatterned surfaces.

31. The microfluidic device of claim 30 and further comprising a via formed through one of the layers.

32. The microfluidic device of claim 31 wherein the via is coupled to a micropatterned surface on each side of the layer such that fluid may flow between layers adjacent to the layer having the via.

33. The microfluidic device of claim 30 wherein selected layers have further microfeatures.
